(19) United States
(12) Patent Application Publication
(10) Pub. No.: US 2020/0304233 A1
(43) Pub. Date: Sep. 24, 2020

(54) Link Adaption in Beam-Forming Radio Access Networks

(71) Applicant: Telefonaktiebolaget LM Ericsson (publ), Stockholm (SE)

(72) Inventors: Virgile GARCIA, ANTIBES (FR); Niklas JALDÉN, ENKÖPING (SE)

(21) Appl. No.: 16/759,624

(22) PCT Filed: Oct. 30, 2017
(86) PCT No.: PCT/CN2017/108412

§ 371 Date: Apr. 27, 2020

(51) Int. Cl. H04L 1/00; H04B 7/06

(52) U.S. Cl. CPC H04L 1/0015; H04L 1/0009; H04L 1/0003; H04B 7/0617

(57) ABSTRACT

There is disclosed a method of operating a radio node (10, 100) in a radio access network, the radio node (10, 100) being adapted for reception beamforming based on radio processing. The method comprises performing link adaptation based on a parametrisation of the radio processing. The disclosure also pertains to related methods and devices.

### TECHNICAL FIELD

This disclosure pertains to wireless communication technology, in particular for 5G technology like LTE Evolution or New Radio (NR).

### BACKGROUND

In modern wireless communication systems, technology utilising multiple antennas or antenna arrays are becoming more widely spread, allowing use of beamforming for transmission (transmission beamforming), but also for reception (reception beamforming). However, handling large sets of beams may become computationally expensive, and may cost valuable time.

Thus, improved ways of handling beams, in particular reception beams, are needed.

### SUMMARY

It is an object of the present disclosure to provide approaches facilitating improvements in the context of reception beam forming. It has been recognised that selective use of reception beams, respectively the radio processing performed for reception beamforming, and link adaptation (e.g., dynamic configuring of modulation and coding scheme, MCS) may advantageously be interconnected. The approaches are particularly suitable for implementation in a 5^{th} Generation (5G) telecommunication network or 5G radio access technology or network (RAT/RAN), in particular according to 3GPP (3^{rd} Generation Partnership Project, a standardisation organization). A suitable RAN may in particular be a RAN according to NR, for example release 15 or later, or LTE Evolution. The approaches may in particular be implemented for radio nodes utilising and/or adapted for MIMO, e.g. MU-MIMO and/or massive MIMO (or VL-MIMO). In particular, beamforming may be MIMO-based.

There is disclosed a method of operating a radio node in a radio access network, the radio node being adapted for reception beamforming based on radio processing. The method comprises performing link adaptation based on a parametrisation of the radio processing.

Also, there is discussed a radio node for a radio access network. The radio node is adapted for reception beamforming based on radio processing. The radio node further is adapted for performing link adaptation based on a parametrisation of the radio processing. It may be considered that the radio node comprises, and/or is adapted for utilising, processing circuitry and/or radio circuitry, for performing link adaptation and/or beamforming. Alternatively, or additionally, the radio node may comprise a corresponding radio processing module and/or a corresponding link adaptation module, for example for performing radio processing and/or link adaptation, respectively.

Moreover, a method of operating a (e.g., second) radio node in a radio access network is considered. The (second) radio node is adapted for reception beamforming based on radio processing. The method comprises performing radio processing based on a parametrisation of link adaptation performed by the (second) radio node. The method of operating the (second) radio node may be implemented in combination with any of the methods of operating a radio node described herein, in particular with performing link adaptation based on a parametrisation of the radio processing.

A (second) radio node for a radio access network is proposed, the radio node being adapted for reception beamforming based on radio processing. The (second) radio node further is adapted for performing radio processing based on a parametrisation of link adaptation performed by the (second) radio node. It may be considered that the (second) radio node comprises, and/or is adapted for utilising, processing circuitry and/or radio circuitry, for performing link adaptation and/or beamforming. Alternatively, or additionally, the radio node may comprise a corresponding radio processing module and/or a corresponding link adaptation module, for example for performing radio processing and/or link adaptation, respectively. The (second) radio node may be implemented in combination with features of any radio node described herein. Circuitry may be shared or distributed.

A radio node may be a network node, in particular a base station or eNodeB or gNodeB. In some variants, the radio node may be implemented as a user equipment. Performing link adaptation may comprise configuring a target radio node with a modulation and coding scheme (e.g., MCS) and/or a transport format. Such a format or scheme may be for reception and/or transmission by the target radio node. Alternatively, or additionally, performing link adaptation may comprise configuring the radio node itself with a MCS and/or transport format. A target radio node may generally be a user equipment. However, in some variants, it may be a network node, e.g. if the radio node configuring it is a user equipment. Reception beams may receive uplink signaling, if the radio node is a network node. If the radio node is a user equipment, reception beams may be for receiving downlink and/or sidelink signaling. A radio node, in particular a network node, may be integrated into one device or housing or rack, or may be distributed over several, which may be connected or connectable via suitable interfaces and/or cables and/or wiring.

Radio processing may generally comprise transforming received signaling into beam space, and/or performing beam selection from a set of defined reception beams, e.g. selecting one or more beams from a set of beams, which may be predefined. Transforming signaling into beam space may comprise spatial transformation, and/or mapping signaling received with different antennas and/or antenna elements and/or antenna groups to one or more beams, e.g. based on phase and/or time of arrival.

A parametrisation of radio processing may parametrise a beam transformation applied, and/or a selection of reception beams, and/or a number of selected reception beams, and/or method of combination of parameters and/or beams. A parametrisation of radio processing may generally be provided by a radio processing process and/or associated module and/or circuitry and/or device. In some variants, a parametrisation of radio processing may indicate and/or represent a preferred transport format. Alternatively, instead of a parametrisation of radio processing, an indication of a preferred transport format may be used.

Generally, a parametrisation of link adaptation may parametrise a transport format and/or modulation and/or coding, for example by indicating and/or indexing a table and/or by indicating a modulation and/or indicating a coding and/or indicating a modulation and coding scheme. A parametrisation of link adaptation may generally be provided by a link adaptation process and/or associated module and/or circuitry and/or device. In some variants, a parametrisation of link adaptation may indicate and/or represent a preferred radio processing, e.g. a beam selection and/or beam space transformation. Alternatively, instead of a parametrisation of link adaption, an indication of preferred radio processing may be used.

Radio processing may comprise performing beam selection from a set of defined reception beams, e.g. based on a reception property. The reception property may in particular pertain to signal quality and/or error rate, e.g. SIR and/or SINR and/or SNR and/or BLER and/or BER. Processing circuitry and/or radio circuitry may be implemented centralized, or distributed, e.g. in different devices and/or packages. In particular, circuitry and/or devices associated to performing link adaptation may be distributed and/or different from circuitry associated to radio processing. The circuitry and/or devices may be connected via suitable interfaces and/or via intermediate devices.

There is also disclosed a program product comprising instructions causing processing circuitry to control and/or perform any of the methods described herein.

Further, a carrier medium arrangement carrying and/or storing a program product as described herein is considered.

A transport format may for example correspond to a modulation scheme, and/or coding, and/or transmission mode, and/or beam forming setup (e.g., number of antennas or antenna elements to use), and/or rank and/or layers of transmission. It may pertain to transmission of signaling, and/or to reception, e.g. by the radio node and/or a target radio node.

Link adaption and/or radio processing like beam forming or beam selection may pertain to a frequency range, e.g. one or more carriers, and/or associated bandwidths or bandwidth parts, and/or may be dependent on numerology. The frequency range and/or numerology may comprise and/or pertain to, and/or be located to cover, 1 GHz or more, 2 GHz or more, 5 GHz or more, or 6 Ghz or more (more referring to higher frequencies). As antenna elements for high frequencies can be comparatively small, a relatively large number may be fitted even to space-limited devices, facilitating particularly efficient use of beam forming. However, the approaches described may be implemented for lower frequencies as well, e.g. depending on the antenna arrangement available for beam forming. Beamforming may in particular be reception beam forming, forming beams from an incoming radiation field, which may result from multiple signaling overlapping at the receiving antenna/s.

In general, a parametrisation may comprise and/or indicate on or more parameters, e.g. values and/or weights, which may be included in a set of parameters.

Selecting one or more beams may include, and/or be based on, performing radio processing and/or further processing of the beam/s. Processing may comprise demodulating and/or decoding signaling received with beams, and/or associating it with specific types of signaling, e.g. as scheduled, and/or to specific channel/s.

Different beams may differ in topology and/or shape and/or angular and/or spatial extension and/or direction and/or size and/or regarding to resources, in particular time and/or frequency resources. Different beams in some cases may overlap, e.g. in angular/spatial extension, and/or time/frequency, or be completely distinct. It may generally be considered that beams of the set are time-shifted, e.g. within the same transmission timing structure, like a transmission time interval or and/or slot or subframe. It should be noted that due to multi-path propagation, signaling from a transmitter may be received in different beams, even if they do not overlap.

The set of beams may comprise a plurality of beams, in particular 2 or more, 4 or more, 8 or more, 10 or more, 12 or more, 16 or more, or 20 or more, or 50 or more beams. The set may pertain to a specific time interval, and/or comprise beams used in and/or defined and/or configured for that interval, e.g. a transmission time interval and/or a transmission timing structure. A beam, or the set of beams, may change over time, e.g. in the time interval, e.g. due to beam switching and/or beam sweeping. The time interval may, for example, be a transmission timing structure. The set of beams may comprise reception beams defined or formed by (reception) beamforming. The set of reception beams may be defined, e.g. based on location of the receiving radio node, and/or may be configured or configurable, e.g. during operation. During operation, it may not be necessary or efficient to use all beams for further processing, such that a selection out of the set may be useful.

Selecting one or more beams may comprise selecting a subset of beams, the subset being smaller than the set, and/or containing and/or consisting of not all beams of the set. The subset thus may be considered a true or limited subset of the set. Beam selection may generally be considered a form of compression, e.g. spatial compression.

The radio processing and/or link adaptation may be performed based on quality of service requirements, e.g. as indicated for specific services and/or radio bearers and/or target radio nodes.

Beamforming may generally comprise utilising independently controllable antenna elements and/or arrays (or subarrays/panels), which may be associated to an antenna arrangement, to produce a directed beam of radiation (for transmission), or to provide a (directional and/or angular, in particular regarding spatial angle) cut-out of an incoming radiation field according to a reception beam, e.g. based on timing and/or phase. A beam may have complicated shape, e.g. it may be multi-lobed, and/or irregular, depending on the number of antenna elements/arrays used for defining it. Reception beamforming may be performed by beamforming circuitry, which may be adapted therefor, and/or may be performed on based on a total receives signal or received radiation field. Depending on implementation, beamforming circuitry may be processing circuitry, and/or antenna circuitry and/or radio circuitry, or implemented separately. An antenna arrangement may comprise a plurality of different antenna elements and/or arrays (or subarrays, e.g. panel/s), which may be independently controllable. Being independently controllable for reception beamforming may be considered to comprise and/or represent that signals representing a received radiation field (e.g., output by an ADC and/or amplifier of associated to the antenna element or array) may be handled (evaluated) independent from signals from other such devices, which may be associated to different array/s and/or antenna element/s. Reception beamforming may comprise a beam space transformation, in which signals from an antenna arrangement, in particular from different independently controllable antenna elements or subarrays or arrays are mapped to define a set of beams in a beam space representation. An antenna arrangement may comprise at least 10, at least 20, at least 50 or at least 70 independently controllable antenna elements or arrays or subarrays, e.g. panels. In some variants, antenna elements may be configurably associated to (different) subarrays. Signals from different antenna elements and/or subarrays or arrays may be combined in different ways, according to a combining scheme, e.g. for beam forming and/or spatial transformation.

### BRIEF DESCRIPTION OF THE DRAWINGS

The drawings are provided to illustrate concepts and approaches described herein, and are not intended to limit their scope. The drawings comprise:

FIG. 1, showing an exemplary flowchart of an algorithm of operating a radio node;

FIG. 2, showing an exemplary radio node;

FIG. 3, showing an exemplary radio node arrangement;

FIG. 4, showing an exemplary radio node implemented as user equipment; and

FIG. 5, showing an exemplary radio node implemented as network node.

### DETAILED DESCRIPTION

Link adaptation (LA) may comprise the process of determining the Modulation and Coding Scheme (MCS) to use for transmissions. This may be considered a prediction of the most proper modulation to use for future outcome. Typically, metrics like SINR are used to map the signal quality to the decoding error probability of the packet. Additionally, to the signal quality prediction, feedback loops can be introduced to inform of the decoding success (or failure) of a given transmission.
Several observations affecting the link adaptation are summarized as:
The decoding probability of a packet may depend on the actual signal quality of the packet, while the available information is only an estimated quality. The accuracy of the estimation or prediction may be critical for efficiency.
The SINR estimation quality is linked to the quality of the channel (and covariance) estimation of received signaling, e.g. on the received ports. The noisier the port, the worse the channel estimation is, and so the estimated SINR is may not be very reliable.
Multi-user MIMO SINR estimation is subject to all co-scheduled user signaling, as well as the quality of the combiner to enhance one signal or to reject interference. Multi-antenna systems allow transmitting signals focused towards certain spatial regions. This creates beams (“beam forming”), whose coverage can go beyond transmissions using non-beamformed signals, but at the cost of narrower (angular/spatial) coverage. This is a classic trade-off between distance and angular coverage. In 5G/NR, radio devices are expected to operate with large number of antennas (“Massive MIMO”), offering flexibility and potentially very narrow beams (very large focusing gain). Massive MIMO makes a clean break with current practice through the use of a very large number of service antennas or antennas (sub)arrays that are operable fully coherently and adaptively.
Spatial transformation introduces a beamforming (pre)processing, e.g. as part of radio processing, that combines the received signaling to focus in different directions to provide beam gains. Some beams concentrate a large portion of the received signaling, while other beams are mostly dominated by noise.
Spatial beam sub-selection also distorts the signal perception by the baseband, by reducing the number of received ports and removing the worst signals.

Spatial transformation, in particular for reception beamforming, may be considered for radio nodes, wherein subsequent processing may be performed in beam space. I

Traditionally, LA is based on a single lookup-table between MCS index and SINR target. That table is based on a specific BLER requirement (e.g. voice), and not adapted to a variety of use-cases. Most transmissions in current systems do not carry voice, such that using the current LA look-up-tables is not optimal for optimizing capacity, for example. The SINR estimated for a given combination of receiver system (beam space, number of beam kept after beam selection, user correlation, combining method) is not giving the same error probability than with other systems. Thus, applying a unique lookup table or mapping could result in a generally underperforming system.

Link adaptation, in particular the modulation and coding scheme, may significantly influence throughput. In particular, the MCS may determine how many bits, e.g. systemic or information bits, may be carried by each symbol. The higher this number, the better the system throughput. On the other hand, higher rate MCS are usually more susceptible to interference or bad transmission conditions.

The decoding performance for a given MCS may significant differ depending on the method used for beam space transformation, as well as the number of dimension kept, e.g. depending on the beam space transformation, and/or beam selection. Using the wrong reference model for link adaptation can therefore lead to decoding errors or sub-optimal resource usage. In some examples, an underestimation (e.g., up to 3 dB difference) may lead to a MCS with a too low bit rate or index (e.g., a transport format whose MCS index could have been 3 or 4 higher, hence have better throughput). An overestimation of even 1 dB can dramatically compromise the chance of success of a given MCS, e.g. lead to a high error rate like a high BLER.

There is proposed adapting the selection of the transport format to the radio processing algorithm and parameter used, e.g. to a parametrisation of the radio processing. For example, the radio processing (e.g., a corresponding circuitry and/or program) may provide, e.g. pass, related information, e.g. indicating the radio processing parametrisation, to the link adaptation (e.g., corresponding circuitry and/or program), so that it can choose the correct transport format.

Alternatively, or additionally, the link adaptation can inform the radio processing of a parametrisation, e.g. indicating the preferred radio processing algorithms and parameters.

The approaches described herein allow dynamic adaptation that allows improved transmissions based on each service content and requirements. Minimizing the amount of retransmissions may be facilitated. Moreover, link adaptation suited for optimizing the overall network performance is provided.

An extended link adaptation scheme is proposed, using the type of service and/or a radio processing parametrisation, in particular information pertaining to spatial transformation (beam space transformation) and/or spatial compression (beam selection) as inputs in the link adaptation scheme. Information or a parametrisation of spatial transformation and/or beam space transformation may be considered to generally represent and/or indicate and/or parametrise reception beams formed, e.g. a (predefined) set of beams. Information or a parametrisation of spatial compression and/or beam selection may be considered to generally represent and/or indicate and/or parametrise one or more beams selected from the set of beams. Given knowledge of the current number of scheduled streams/layers and the service used on these together with the planned spatial transformation method and level of spatial compression, selecting an appropriate transport format is facilitated. Radio processing informing link adaptation, or vice versa, may comprise providing corresponding information over one or more interfaces, which may be arranged between modules and/or devices adapted for radio processing and link adaptation, respectively (and optionally one or more intermediate device/s and/or module/s).

The selection of a transport format (e.g. link adaption, and/or selecting MCS) may be based on the spatial processing and preprocessing. The system preprocessing settings can be fixed (e.g., network or site dependent) or dynamically changed. The link adaptation, e.g. based on one or more system-specific tables, may then, for example, select the (optimal) transport format depending on QoS requirements.

Depending on the application, the link adaptation may choose the MCS that matches the traffic requirements (e.g. a given BLER target or data-rate target, which may be considered exemplary QoS requirements). Having detailed BLER to SINR performance information for each MCS and each radio receiver may optimize LA.

Alternatively, or additionally, radio processing, e.g. a radio unit and/or baseband unit performing radio processing, may inform the link adaptation (e.g., a device or unit or circuitry performing such) of a radio processing parametrisation, e.g. the transformation and/or compression methods and/or related parameters. Such a solution may be particularly useful for dynamically changing systems. Information passed from the radio (indicating a parametrisation of radio processing) may for example indicate (but is not limited to):
The spatial transformation applied (e.g. SVD, DFT, Codebook, . . . ); and/or
The method used to select beams and/or perform compression; and/or
The number of beams selected; and/or
The combining method/s used (e.g. IRC, MRC, hybrid, . . . ).

Alternatively, or additionally, performance versus signal quality mapping information may be predetermined based on for example offline computation, simulations, analysis, etc. Such information may map link adaptation to radio processing and/or vice versa, and/or pertain to corresponding parametrisations.

Alternatively, or additionally, performance versus signal quality mapping may be dynamically obtained or updated, e.g. for each radio processing combination/parametrisation. This may be particularly useful for dynamic systems, e.g. if the beam selection is adapted over time, e.g. between transmission timing structures, or in constant or changing time intervals. For example, the radio processing, e.g. corresponding unit(s), may feedback (inform about) the processing methods and parameters used for each (or a subsample of) the data processed and the estimated SINR. A decoding unit may feed back the decoding success (or failure) information. Statistics, for each parameter and each SINR may be stored and updated to determine the success probability of each system parameter and estimated SINR.

The update process may be dynamic and updated for separate types of services, data transmissions, voice, etc. (or even more detailed based on higher order applications).

Link adaptation may use a combination of methods and parameters, and may feed a corresponding parametrisation back to the radio processing, e.g. a corresponding unit. The hypothesis selected in the MCS selection may thus be matched. A suitable communication channel and/or interface/s between the link adaptation and radio processing, e.g. spatial transformation/sub-selection and combining units, may be provided.

It should be noted that radio processing may be performed in one or more units and/or devices and/or modules and/or circuitry/ies (which in the following may be referred to simply as devices for ease of reference), which may be implemented integrated or distributed, or in a combination thereof.

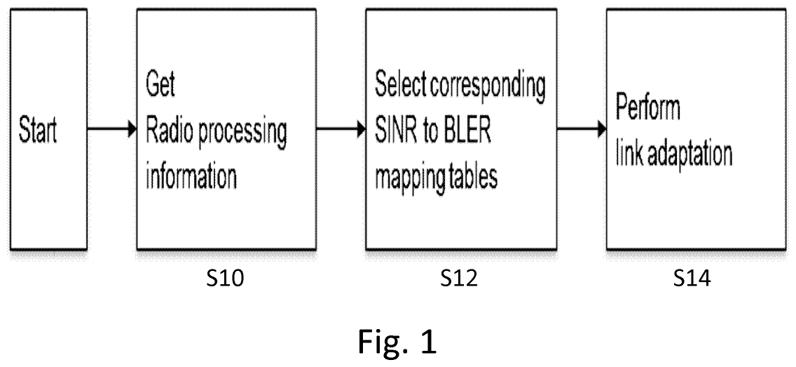

FIG. 1 shows a flow chart of an exemplary algorithm or method of operating a radio node. In an action S10, radio processing information, e.g. representing a parametrisation of radio processing, may be provided, e.g. by a radio processing unit or device or module. Based on this information, a suitable mapping of SINR to BLER may be selected, e.g. based on one or more tables. Link adaptation may be performed based on the mapping in an action S14, which thus is based on the parametrisation of radio processing.

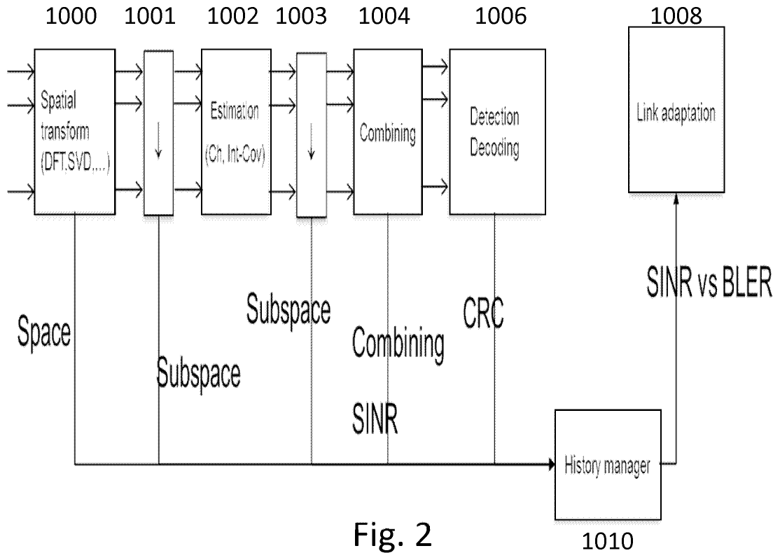

FIG. 2 shows an exemplary setup for the approaches described herein, which may represent a radio node and devices thereof. A transformation device 1000 may be adapted to perform spatial transformation on incoming and/or received signaling, which may be based on signals received from an antenna arrangement. The signals may be subjected to DFT and/or SVD and/or other transformation to derive a set of (e.g., predefined) beams, which may be considered to provide a beam space representation. The beam space representation (Space) may be indicated in a parametrisation of radio processing. Some further processing like beam selection may be performed in an optional beam selection device 1001, which may select a subset of beams. The subset may be considered to represent a subspace, which may be represented in a radio processing parametrisation accordingly. Channel estimation may be performed, e.g. in a estimation device 1002, based on the beam space representation and/or the subset. Optionally, a beam selection may be performed based on the channel estimation (e.g., instead of performing it before in device 1001), in an optional beam selection device 1003, which may provide a subspace representation analogous to the one mentioned above. A parametrisation of radio processing representing e.g. a subspace may be based on the channel estimation, either directly (e.g., omitting device 1003) or indirectly, e.g. if the device 1003 is utilised, or a combination thereof. A combining device 1004 may perform combining, e.g. based on a selected beam subset and/or channel estimation, and/or based on channels and/or bearers and/or QoS and/or for users (representing target radio node/s). Such combining may indicate channel quality, e.g. parametrised as SINR. Device 1004 may provide parametrisation of combining and/or channel quality as radio processing parametrisation. Based on the combining, a detection device 1006 may perform detection and/or decoding, e.g. of signaling and/or channels. Resulting error detection and/or correction, and/or associated error rate may be indicated as radio processing parametrisation, which may be based on CRC, which may be used for error detection. Parametrisation of radio processing may be provided by at least one of the device, or by any combination of devices. Optionally, such parametrisation may be provided to an optional history manager 1010 (which may be a history device), which may store and/or update the corresponding information, and/or process it, e.g. to provide an average or mean representation, and/or a time development. A link adaptation device 1008 may generally perform link adaptation on the parametrisation of radio processing provided, e.g. by one or more of the devices 1000-1006, and/or the history manager 1010. Link adaptation may be performed based on a performance mapping, e.g. indicating a SINR vs BLER mapping, and/or based on channel quality and/or QoS. It should be noted that a parametrisation of link adaptation may be indicated to one or more of the radio processing devices 1000-1006, in addition or in alternative to the information flow indicated in FIG. 2.

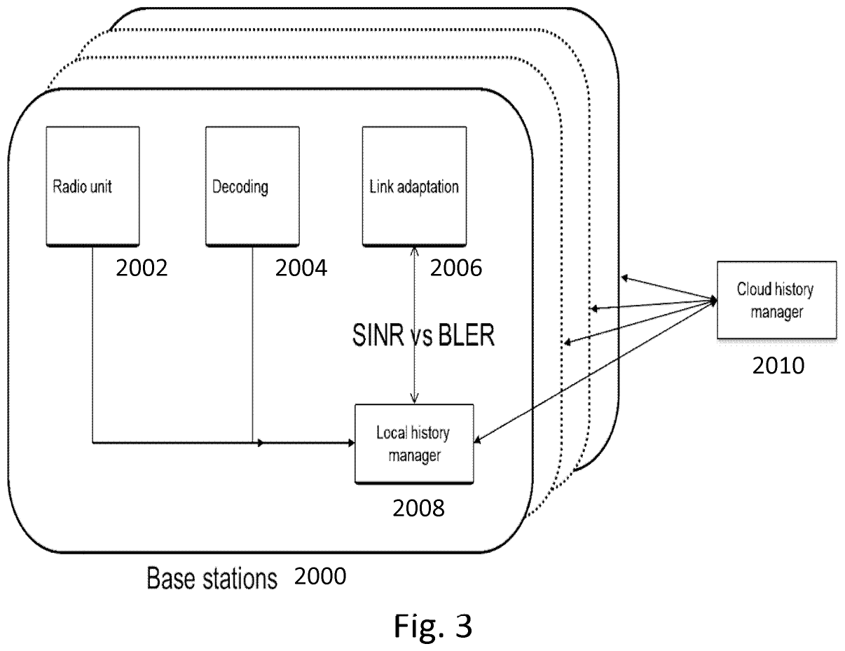

In particular storing and analyzing the estimated SINR vs BLER performance of each receiver type can take advantage of a cloud architecture or radio node arrangement, as shown exemplarily in FIG. 3. The performance mapping can be shared to improve accuracy and the analysis can take advantage of cluster/cloud computing power to employ efficient computation. Radio nodes, e.g. one or more base stations 2000, can be regularly updated or can do on-demand BLER performance request to the cloud comprising a cloud history manager 2010, which may receive parametrisation information from the nodes, and may replace and/or complement history managers 2010. The cloud history manager may be provided on one or more of the radio nodes, or be provided separately. Each radio node 2000 may comprise one or more of the devices described above, e.g. a radio unit 2002 representing one or more of devices 1000-1004, and/or a decoding device 2004 corresponding to device 1006, and/or a link adaptation unit 2006 corresponding to device 1008.

According to described approaches, a Link Adaptation reference input that adapts to the radio receiver used may be considered. Since the radio receiver algorithms and properties (in particular the spatial transformation and compression) affect the decoding performance for a given estimated SINR, it is proposed to use and maintain a plurality of referring information that the LA can use.

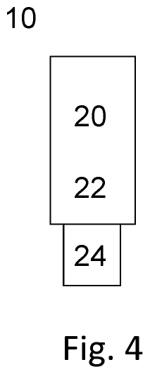

FIG. 4 schematically shows a radio node, in particular a terminal or wireless device 10, which may in particular be implemented as a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g. a RAN as described herein, and/or for sidelink communication. Radio node 10 may generally be adapted to carry out any of the methods of operating a radio node like terminal or UE disclosed herein; in particular, it may comprise corresponding circuitry, e.g. processing circuitry, and/or modules.

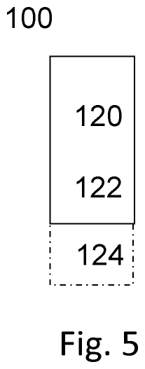

FIG. 5 schematically show a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g. processing circuitry, and/or modules. The radio node 100 may generally comprise communication circuitry, e.g. for communication with another network node, like a radio node, and/or with a core network and/or an internet or local net, in particular with an information system, which may provide information and/or data to be transmitted to a user equipment.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is considered. The system may be a wireless communication system, and/or provide and/or represent a radio access network.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Reference signaling may be signaling comprising one or more reference symbols and/or structures. Reference signaling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signaling are available for both transmitter and receiver of the signaling (e.g., due to being predefined and/or configured or configurable and/or being communicated). Different types of reference signaling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signaling) and/or phase-related, etc.

An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangements associated to a UE or terminal may be smaller (e.g., in size and/or number of antenna elements or arrays) than the antenna arrangement associated to a network node. Antenna elements of an antenna arrangement may be configurable for different arrays, e.g. to change the beam forming characteristics. In particular, antenna arrays may be formed by combining one or more independently or separately controllable antenna elements or subarrays. The beams may be provided by analog beamforming, or in some variants by digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) to convert digital control information into an analog antenna feed for the whole antenna arrangement (the ADC may be considered part of, and/or connected or connectable to, antenna circuitry). A scenario in which each antenna element is individually controllable may be referred to as digital beamforming, whereas a scenario in which larger arrays/subarrays are separately controllable may be considered an example of analog beamforming. Hybrid forms may be considered.

Uplink or sidelink signaling may be OFDMA (Orthogonal Frequency Division Multiple Access) or SC-FDMA (Single Carrier Frequency Division Multiple Access) signaling. Downlink signaling may in particular be OFDMA signaling. However, signaling is not limited thereto (Filter-Bank based signaling may be considered one alternative).

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN as described herein.

The terms wireless device, user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, a RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A radio access network may be a wireless communication network, and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signaling (control signaling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signaling, e.g. as a form of control information or signaling like uplink control information/signaling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signaling.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling, e.g. comprising or representing acknowledgement signaling and/or resource requesting information, may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signaling as described herein, based on the utilised resource sequence, implicitly indicates the control signaling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signaling, e.g. according to a specific format, may be communicated, for example transmitted and/or received, and/or be intended for transmission and/or reception.

A border symbol may generally represent a starting symbol or an ending symbol for transmitting and/or receiving. A starting symbol may in particular be a starting symbol of uplink or sidelink signaling, for example control signaling or data signaling. Such signaling may be on a data channel or control channel, e.g. a physical channel, in particular a physical uplink shared channel (like PUSCH) or a sidelink data or shared channel, or a physical uplink control channel (like PUCCH) or a sidelink control channel. If the starting symbol is associated to control signaling (e.g., on a control channel), the control signaling may be in response to received signaling (in sidelink or downlink), e.g. representing acknowledgement signaling associated thereto, which may be HARQ or ARQ signaling. An ending symbol may represent an ending symbol (in time) of downlink or sidelink transmission or signaling, which may be intended or scheduled for the radio node or user equipment. Such downlink signaling may in particular be data signaling, e.g. on a physical downlink channel like a shared channel, e.g. a PDSCH (Physical Downlink Shared Channel). A starting symbol may be determined based on, and/or in relation to, such an ending symbol.

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor.

A resource structure may be considered to be neighbored in frequency domain by another resource structure, if they share a common border frequency, e.g. one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighbored in time domain by another resource structure, if they share a common border time, e.g. one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighbored by another resource structure in a domain may also be referred to as abutting and/or bordering the other resource structure in the domain.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of subcarrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising microwave and/or millimeter and/or other frequencies, in particular between 100 MHz or 1 GHz, and 100 GHz or 20 or 10 GHz. Such communication may utilise one or more carriers.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g. prefix or postfix.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signaling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. a LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signaling. Communication on a sidelink (or sidelink signaling) may comprise utilising the sidelink for communication (respectively, for signaling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be send over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A configuration or schedule, like a mini-slot configuration and/or structure configuration, may schedule transmissions, e.g. for the time/transmissions it is valid, and/or transmissions may be scheduled by separate signaling or separate configuration, e.g. separate RRC signaling and/or downlink control information signaling. The transmission/s scheduled may represent signaling to be transmitted by the device for which it is scheduled, or signaling to be received by the device for which it is scheduled, depending on which side of a communication the device is. It should be noted that downlink control information or specifically DCI signaling may be considered physical layer signaling, in contrast to higher layer signaling like MAC (Medium Access Control) signaling or RRC layer signaling. The higher the layer of signaling is, the less frequent/the more time/resource consuming it may be considered, at least partially due to the information contained in such signaling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time for intended or scheduled or reserved for control signaling, in particular downlink control signaling, and/or for a specific control channel, e.g. a physical downlink control channel like PDCCH. The interval may comprise, and/or consist of, a number of symbols in time, which may be configured or configurable, e.g. by (UE-specific) dedicated signaling (which may be single-cast, for example addressed to or intended for a specific UE), e.g. on a PDCCH, or RRC signaling, or on a multicast or broadcast channel. In general, the transmission timing structure may comprise a control region covering a configurable number of symbols. It may be considered that in general the border symbol is configured to be after the control region in time.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

Scheduling a device, or for a device, and/or related transmission or signaling, may be considered comprising, or being a form of, configuring the device with resources, and/or of indicating to the device resources, e.g. to use for communicating. Scheduling may in particular pertain to a transmission timing structure, or a substructure thereof (e.g., a slot or a mini-slot, which may be considered a substructure of a slot). It may be considered that a border symbol may be identified and/or determined in relation to the transmission timing structure even if for a substructure being scheduled, e.g. if an underlying timing grid is defined based on the transmission timing structure. Signaling indicating scheduling may comprise corresponding scheduling information and/or be considered to represent or contain configuration data indicating the scheduled transmission and/or comprising scheduling information. Such configuration data or signaling may be considered a resource configuration or scheduling configuration. It should be noted that such a configuration (in particular as single message) in some cases may not be complete without other configuration data, e.g. configured with other signaling, e.g. higher layer signaling. In particular, the symbol configuration may be provided in addition to scheduling/resource configuration to identify exactly which symbols are assigned to a scheduled transmission. A scheduling (or resource) configuration may indicate transmission timing structure/s and/or resource amount (e.g., in number of symbols or length in time) for a scheduled transmission.

A scheduled transmission may be transmission scheduled, e.g. by the network or network node. Transmission may in this context may be uplink (UL) or downlink (DL) or sidelink (SL) transmission. A device, e.g. a user equipment, for which the scheduled transmission is scheduled, may accordingly be scheduled to receive (e.g., in DL or SL), or to transmit (e.g. in UL or SL) the scheduled transmission. Scheduling transmission may in particular be considered to comprise configuring a scheduled device with resource/s for this transmission, and/or informing the device that the transmission is intended and/or scheduled for some resources. A transmission may be scheduled to cover a time interval, in particular a successive number of symbols, which may form a continuous interval in time between (and including) a starting symbol and an ending symbols. The starting symbol and the ending symbol of a (e.g., scheduled) transmission may be within the same transmission timing structure, e.g. the same slot. However, in some cases, the ending symbol may be in a later transmission timing structure than the starting symbol, in particular a structure following in time. To a scheduled transmission, a duration may be associated and/or indicated, e.g. in a number of symbols or associated time intervals. In some variants, there may be different transmissions scheduled in the same transmission timing structure. A scheduled transmission may be considered to be associated to a specific channel, e.g. a shared channel like PUSCH or PDSCH.

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signaling, e.g. control signaling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signaling, in particular RCL layer signaling and/or RRC signaling and/or MAC signaling.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

Feedback signaling may be considered a form or control signaling, e.g. uplink or sidelink control signaling, like UCI (Uplink Control Information) signaling or SCI (Sidelink Control Information) signaling. Feedback signaling may in particular comprise and/or represent acknowledgement signaling and/or acknowledgement information and/or measurement reporting.

Acknowledgement information may comprise an indication of a specific value or state for an acknowledgement signaling process, e.g. ACK or NACK or DTX. Such an indication may for example represent a bit or bit value or bit pattern or an information switch. Different levels of acknowledgement information, e.g. providing differentiated information about quality of reception and/or error position in received data element/s may be considered and/or represented by control signaling. Acknowledgment information may generally indicate acknowledgment or non-acknowledgment or non-reception or different levels thereof, e.g. representing ACK or NACK or DTX. Acknowledgment information may pertain to one acknowledgement signaling process. Acknowledgement signaling may comprise acknowledgement information pertaining to one or more acknowledgement signaling processes, in particular one or more HARQ or ARQ processes. It may be considered that to each acknowledgment signaling process the acknowledgement information pertains to, a specific number of bits of the information size of the control signaling is assigned. Measurement reporting signaling may comprise measurement information.

Signaling may generally comprise one or more symbols and/or signals and/or messages. A signal may comprise and/or represent one or more bits, which may be modulated into a common modulated signal. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different acknowledgement signaling processes, e.g. representing and/or pertaining to one or more such processes. An indication may comprise signaling and/or a plurality of signals and/or messages and/or may be comprised therein, which may be transmitted on different carriers and/or be associated to different acknowledgement signaling processes, e.g. representing and/or pertaining to one or more such processes.

Signaling utilising, and/or on and/or associated to, resources or a resource structure may be signaling covering the resources or structure, signaling on the associated frequency/ies and/or in the associated time interval/s. It may be considered that a signaling resource structure comprises and/or encompasses one or more substructures, which may be associated to one or more different channels and/or types of signaling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signaling.

It should generally be noted that the number of bits or a bit rate associated to specific signaling that can be carried on a resource element may be based on a modulation and coding scheme (MCS). Thus, bits or a bit rate may be seen as a form of resources representing a resource structure or range in frequency and/or time, e.g. depending on MCS. The MCS may be configured or configurable, e.g. by control signaling, e.g. DCI or MAC (Medium Access Control) or RRC (Radio Resource Control) signaling.

Different formats of for control information may be considered, e.g. different formats for a control channel like a Physical Uplink Control Channel (PUCCH). PUCCH may carry control information or corresponding control signaling, e.g. Uplink Control Information (UCI). UCI may comprise feedback signaling, and/or acknowledgement signaling like HARQ feedback (ACK/NACK), and/or measurement information signaling, e.g. comprising Channel Quality Information (CQI), and/or Scheduling Request (SR) signaling. One of the supported PUCCH formats may be short, and may e.g. occur at the end of a slot interval, and/or multiplexed and/or neighboring to PUSCH. Similar control information may be provided on a sidelink, e.g. as Sidelink Control Information (SCI), in particular on a (physical) sidelink control channel, like a (P)SCCH.

A code block may be considered a subelement of a data element like a transport block, e.g., a transport block may comprise a one or a plurality of code blocks.

A scheduling assignment may be configured with control signaling, e.g. downlink control signaling or sidelink control signaling. Such controls signaling may be considered to represent and/or comprise scheduling signaling, which may indicate scheduling information. A scheduling assignment may be considered scheduling information indicating scheduling of signaling/transmission of signaling, in particular pertaining to signaling received or to be received by the device configured with the scheduling assignment. It may be considered that a scheduling assignment may indicate data (e.g., data block or element and/or channel and/or data stream) and/or an (associated) acknowledgement signaling process and/or resource/s on which the data (or, in some cases, reference signaling) is to be received and/or indicate resource/s for associated feedback signaling, and/or a feedback resource range on which associated feedback signaling is to be transmitted. Transmission associated to an acknowledgement signaling process, and/or the associated resources or resource structure, may be configured and/or scheduled, for example by a scheduling assignment. Different scheduling assignments may be associated to different acknowledgement signaling processes. A scheduling assignment may be considered an example of downlink control information or signaling, e.g. if transmitted by a network node and/or provided on downlink (or sidelink control information if transmitted using a sidelink and/or by a user equipment).

A scheduling grant (e.g., uplink grant) may represent control signaling (e.g., downlink control information/signaling). It may be considered that a scheduling grant configures the signaling resource range and/or resources for uplink (or sidelink) signaling, in particular uplink control signaling and/or feedback signaling, e.g. acknowledgement signaling. Configuring the signaling resource range and/or resources may comprise configuring or scheduling it for transmission by the configured radio node. A scheduling grant may indicate a channel and/or possible channels to be used/usable for the feedback signaling, in particular whether a shared channel like a PUSCH may be used/is to be used. A scheduling grant may generally indicate uplink resource/s and/or an uplink channel and/or a format for control information pertaining to associated scheduling assignments. Both grant and assignment/s may be considered (downlink or sidelink) control information, and/or be associated to, and/or transmitted with, different messages.

A resource structure in frequency domain (which may be referred to as frequency interval and/or range) may be represented by a subcarrier grouping. A subcarrier grouping may comprise one or more subcarriers, each of which may represent a specific frequency interval, and/or bandwidth. The bandwidth of a subcarrier, the length of the interval in frequency domain, may be determined by the subcarrier spacing and/or numerology. The subcarriers may be arranged such that each subcarrier neighbours at least one other subcarrier of the grouping in frequency space (for grouping sizes larger than 1). The subcarriers of a grouping may be associated to the same carrier, e.g. configurably or configured of predefined. A physical resource block may be considered representative of a grouping (in frequency domain). A subcarrier grouping may be considered to be associated to a specific channel and/or type of signaling, it transmission for such channel or signaling is scheduled and/or transmitted and/or intended and/or configured for at least one, or a plurality, or all subcarriers in the grouping. Such association may be time-dependent, e.g. configured or configurable or predefined, and/or dynamic or semi-static. The association may be different for different devices, e.g. configured or configurable or predefined, and/or dynamic or semi-static. Patterns of subcarrier groupings may be considered, which may comprise one or more subcarrier groupings (which may be associated to same or different signalings/channels), and/or one or more groupings without associated signaling (e.g., as seen from a specific device). An example of a pattern is a comb, for which between pairs of groupings associated to the same signaling/channel there are arranged one or more groupings associated to one or more different channels and/or signaling types, and/or one or more groupings without associated channel/signaling).

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.).

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM). While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Some useful abbreviations comprise

| Abbreviation | Explanation |
|---|---|
| ACK/NACK | Acknowledgment/Negative Acknowledgement |
| ARQ | Automatic Repeat request |
| BER | Bit Error Rate |
| BLER | Block Error Rate |
| CAZAC | Constant Amplitude Zero Cross Correlation |
| CBG | Code Block Group |
| CDM | Code Division Multiplex |
| CM | Cubic Metric |
| CQI | Channel Quality Information |
| CRC | Cyclic Redundancy Check |
| CRS | Common reference signal |
| CSI | Channel State Information |
| CSI-RS | Channel state information reference signal |
| DAI | Downlink Assignment Indicator |
| DCI | Downlink Control Information |
| DFT | Discrete Fourier Transform |
| DM(-)RS | Demodulation reference signal(ing) |
| FDM | Frequency Division Multiplex |
| HARQ | Hybrid Automatic Repeat Request |
| IFFT | Inverse Fast Fourier Transform |
| IRC | Interference Rejection Combining |
| LA | Link Adaptation |
| MBB | Mobile Broadband |
| MCS | Modulation and Coding Scheme |
| MIMO | Multiple-input-multiple-output |
| MMSE | Minimum Mean Square Error |
| MRC | Maximum-ratio combining |
| MRT | Maximum-ratio transmission |
| MU-MIMO | Multiuser multiple-input-multiple-output |
| OFDM/A | Orthogonal Frequency Division Multiplex/Multiple Access |
| PAPR | Peak to Average Power Ratio |
| PDCCH | Physical Downlink Control Channel |
| PDSCH | Physical Downlink Shared Channel |
| PRACH | Physical Random Access CHannel |
| PRB | Physical Resource Block |
| PUCCH | Physical Uplink Control Channel |
| PUSCH | Physical Uplink Shared Channel |
| (P)SCCH | (Physical) Sidelink Control Channel |
| (P)SSCH | (Physical) Sidelink Shared Channel |
| QoS | Quality of Service |
| RB | Resource Block |
| RRC | Radio Resource Control |
| SC-FDM/A | Single Carrier Frequency Division Multiplex/Multiple |
| | Access |
| SCI | Sidelink Control Information |
| SINR | Signal-to-interference-plus-noise ratio |
| SIR | Signal-to-interference ratio |
| SNR | Signal-to-noise-ratio |
| SR | Scheduling Request |
| SRS | Sounding Reference Signal(ing) |
| SVD | Singular-value decomposition |
| TDM | Time Division Multiplex |
| UCI | Uplink Control Information |
| UE | User Equipment |
| URLLC | Ultra Low Latency High Reliability Communication |
| VL-MIMO | Very-large multiple-input-multiple-output |
| ZF | Zero Forcing |

Abbreviations may be considered to follow 3GPP usage as applicable.

1. Method of operating a radio node in a radio access network, the radio node being adapted for reception beamforming based on radio processing, the method comprising performing link adaptation based on a parametrisation of the radio processing.

2. Radio node for a radio access network, the radio node being adapted for reception beamforming based on radio processing, the radio node further being adapted for performing link adaptation based on a parametrisation of the radio processing.

3. Method of operating a radio node in a radio access network, the radio node being adapted for reception beamforming based on radio processing, the method comprising performing radio processing based on a parametrisation of link adaptation performed by the radio node.

4. Radio node for a radio access network, the radio node being adapted for reception beamforming based on radio processing, the radio node further being adapted for performing radio processing based on a parametrisation of link adaptation performed by the radio node.

5. Method or device according to claim 4, wherein performing link adaptation comprises configuring a target radio node with a modulation and coding scheme and/or a transport format.

6. Method or device according to claim 4, wherein radio processing comprises transforming received signaling into beam space, and/or performing beam selection from a set of defined reception beams.

7. Method or device according to claim 4, wherein a parametrisation of radio processing parametrises a transformation applied, and/or selection of reception beams, and/or number of selected reception beams, and/or method of combination of parameters and/or beams.

8. Method or device according to claim 4, wherein a parametrisation of link adaptation parametrises a transport format and/or modulation and/or coding, for example by indicating and/or indexing a table and/or by indicating a modulation and/or indicating a coding and/or indicating a modulation and coding scheme.

9. Method or device according to claim 4, wherein radio processing comprises performing beam selection from a set of defined reception beams based on a reception property, wherein the reception property may pertain to signal quality and/or error rate.

10. Program product comprising instructions causing processing circuitry to control and/or perform a method according to claim 1.

11. Carrier medium arrangement carrying and/or storing a program product according to claim 10.
